(19) United States
(12) Patent Application Publication
(10) Pub. No.: US 2013/0196754 A1
(43) Pub. Date: Aug. 1, 2013

(54) METHOD AND COMPUTERIZED SYSTEM FOR PROVIDING GAMING INSTRUCTIONS AND INFORMATION

(71) Applicant: Brent Burns, Nitro, WV (US)

(72) Inventor: Brent Burns, Nitro, WV (US)

(21) Appl. No.: 13/756,343

(22) Filed: Jan. 31, 2013

Related U.S. Application Data
(60) Provisional application No. 61/592,777, filed on Jan. 31, 2012.

(51) Int. Cl. G07F 17/32

(52) U.S. Cl. CPC G07F 17/3288
USPC 463/28; 463/25; 463/43

(57) ABSTRACT

A method and computerized system for providing gaming instructions and information is comprised of at least an information database, a processor executing machine readable instructions, and a user interface. The database initially comprises information about racers such as thoroughbreds, trotters, and greyhounds, and the races in which they are matched. The processor and user interface can receive input from a user which may be added to the database. The user provides a user profile and preferred categories for selecting racers. The categories may be statistical or lucky categories and the lucky categories may require additional selection by the user. The system scores the racers based on the selected categories and generates suggested wagers and instructions for placing the wagers. The suggested wagers generated vary by user profile such as beginner, intermediate, or advanced, and user betting style preference.

### RELATED U.S. APPLICATION DATA

This application claims priority from U.S. Provisional Application No. 61/592,777, filed on Jan. 31, 2012. The entire disclosures contained in U.S. Provisional Application 61/592,777, including the attachments thereto, are incorporated herein by reference.

### BACKGROUND OF THE INVENTION

This application relates generally to a method for providing instructions for placing wagers. More specifically this application relates to a method for providing instructions for placing parimutuel wagers on races based on information about the wagerer, or bettor, and specifics relating to a given race. Parimutuel wagering is a type of wagering where an administrative fee is deducted from the total pool of wagers and the remaining pool is divided among those who placed winning wagers according to the final odds before the event. The odds for the event are determined by the actual wagers placed. In a race, the racer receiving the most bets will be considered the favorite to win and therefore have better odds to win and pay less to the bettor. Racers receiving fewer bets will have poorer odds to win and will pay more to a bettor who wagers money on them. The system used to calculate the wagers and resulting odds for parimutuel events is sometimes called a totalizer or tote.

Parimutuel wagering on greyhound, thoroughbred, and harness racing has a long history as a leading form of entertainment in the United States and abroad. However, the popularity of the pari-mutuel wagering product has been in steady decline for a number of years, with competition from other forms of gambling and entertainment chipping away at its share of the overall entertainment market. One of the primary causes of this decline is that—as society has changed—the way entertainment products are offered and consumed has changed. Parimutuel wagering products have failed to change and keep up with these changes. Today's parimutuel product, and specifically how the wagering experience is offered to customers, is virtually the same as it was fifty years ago. Racing programs (sometimes called a “racing form”), which offer vast amounts of information related to individual thoroughbred and greyhound races for the purpose of selecting a player's desired wagers, are nearly identical in format and layout today as that used fifty years ago. The format of the information that is presented to players in these programs is difficult to understand and intimidating to many new or novice players, and the process of analyzing the information to make wagering selections is very time consuming.

### RELEVANT ART

A series of patents issued to Brenner et al., each titled “INTERACTIVE WAGERING SYSTEMS AND PROCESSES.” These patents include U.S. Pat. No. 5,830,068, U.S. Pat. No. 6,004,211. U.S. Pat. No. 6,089,981, U.S. Pat. No. 6,099,409, U.S. Pat. No. 6,554,708 B1, and U.S. Pat. No. 6,554,709 B1. These patents are directed mostly to the display of race information, such as handicapping information and video displays of actual races, and the selection of wagers over an electronic system. The specification upon which all of these patents are based also discloses the capability for a user to assign weights to handicapping categories to develop personal power ratings for a user. The user can then use the personal power ratings from their entered weights to decide on what their wager will be. The patents by Brenner et al. that allow the use of personal power ratings require some level of knowledge on the part of the user.

U.S. Pat. No. 6,712,701 B1 by Boylan, III, et al. is for an “Electronic book interactive wagering system.” In U.S. Pat. No. 6,712,701 B1, an interactive wagering system is provided in which users may download electronic racing forms to electronic books. The content of the racing form may be directed toward horse racing. The racing form may be interactive. When a user selects an item from a racing form displayed on the electronic book, the user may be presented with additional information or interactive screens that provide racing-related services such as interactive wagering opportunities. The electronic book may be provided with updated racing data. The user may adjust delivery settings for the racing data. News flashes and other real-time reports may be provided to the electronic book. Such reports may be based on the user's preferences and the user's monitored interests. The electronic racing form may include racing data, racing articles, and advertisements. Boylan, III, et al. presents a racing form in its traditional format and therefore offers no new assistance to a novice or to a person wanting to streamline the wager process.

U.S. Pat. No. 6,674,448 B1 by Garahi et al. is for an “Interactive wagering system with controllable graphic displays.” In U.S. Pat. No. 6,674,448 B1, a system is provided in which locally-generated graphics may be displayed on a user's equipment. The user's equipment may be based on a set-top box and television or other user television equipment, a personal computer or handheld computing device or other user computer equipment, or a cellular telephone with a display or other user telephone equipment. The locally-generated graphics may be displayed as an overlay on top of video or as wrap-around graphics on the same screen as a reduced-size video window. The video and the graphics may be related to wagering and in particular may be related to horse racing. The user may interactively wager on horse races with the user equipment. Garahi focuses on displaying locally-generated graphics and displaying video, and offers no assistance to a user in deciphering the information on a racing form.

There remains a need for a system that assists newer individuals in deciphering the large amount of information in racing forms. The various embodiments of the present inventions allows inexperienced individuals to participate in pari-mutuel wagering with a minimal of understanding of racing forms while maintaining the ability to control their wager levels and styles. Alternatively, the various embodiments of the present invention can allow experienced individuals to focus on their preferred statistical categories in a more streamlined fashion.

### SUMMARY OF THE INVENTION

Embodiments of the current invention comprise an interactive program system that has a database of all race related statistics and information, a user interface for conveying and receiving information, a program structure for querying a user about user information and preferences and adding that information to the program database, and a program structure for presenting information from the race database to a user based on user information and inputs. The race information is presented to the user in graphical formats and text and provides suggestions for wagers based on the user's preferences and profile. The interactive program system simplifies the process of understanding and wagering on pari-mutuel races by using a series of simple questions to determine the player's experience level, wagering preferences, and handicapping methods and then summarizes the large amount of data contained on a typical program page into a few simple pictures, charts, graphics, and animations (as an alternative to a typical racing program page).

The data surrounding a prospective race can be quite large. Models within the interactive program system summarize concrete statistical information in picture, chart, graph, and animated formats to help the player reduce over 1,300 pieces of data on a typical greyhound program page or over 3,000 pieces of data in a thoroughbred program page into a much less intimidating visual representation of that information. The player can pick and choose the type and complexity of the information he wishes to see (hard stats versus lucky factors), how much he would like to wager per race, and what type of returns he would like to see (smaller payoffs with more action versus jackpot type payoffs). Based on the player's preferences, the information contained in a program page will be summarized in an uncomplicated graphical format and wagering suggestions will be made for the player. Based on the player's experience level, the models used in the interactive program system can be scaled to fit everyone from the first time patron at a racetrack to an experienced player looking to streamline or speed up their handicapping.

The interactive program system can be presented to players in a variety of formats and technologies. Among the user interfaces that can be used to interact with users are an interactive touch screen computer system in the casino environment, a resident application installed on smart phones and tablet computing devices, or a website accessed online. The particular format and graphics may adapt to the technology used for the interface.

### BRIEF DESCRIPTION OF THE DRAWINGS

FIG. 1 is a block diagram showing the flow of interactive program system 10 and information flow to and from the database.

FIG. 2 shows the database at the core of the system with several sets of tables and data sets within it.

FIG. 3 shows an embodiment of a data set pertaining to race details.

FIG. 4 shows an embodiment of a data set pertaining to greyhound profiles.

FIG. 5 shows an embodiment of a data set pertaining to kennels supplying greyhound for races.

FIG. 6 shows an embodiment of a data set pertaining to post positions.

FIG. 7 shows an embodiment of a data set pertaining to sires of greyhounds entered in a race.

FIG. 8 illustrates the steps and questions used to establish an initial player profile.

FIG. 9 illustrates prompts for a player to make a selection of the type of information a player prefers to use to make his wagers.

FIG. 10 illustrates additional selections a player can make regarding the type of statistical information a player prefers to use to make his wagers.

FIG. 11 illustrates additional selections a player can make regarding the type of fun fact, or background, information a player prefers to use to make his wagers.

FIG. 12 illustrates a decision tree used by the system to use selections made by a beginner player.

FIG. 13 illustrates a decision tree used by the system to use selections made by an intermediate player.

FIG. 14 illustrates a decision tree used by the system to use selections made by an advanced player.

FIG. 15 shows a screen capture from a user interface with a sample graphic for presenting statistical information.

FIG. 16 is a screen capture from a user interface showing a recommended wager.

FIG. 17 is a screen capture from a user interface showing possible video hosts.

FIG. 18 shows several possible user interfaces.

### DETAILED DESCRIPTION OF EMBODIMENTS OF THE INVENTION

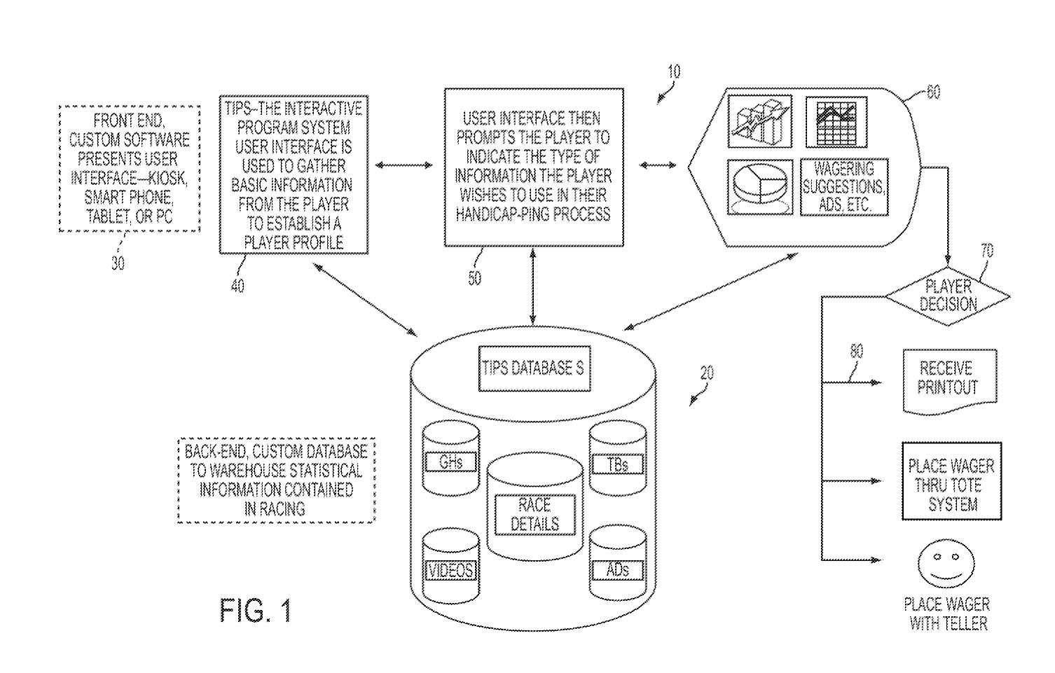

FIG. 1 is a block diagram showing the flow of system 10 and information flow to and from database 20. At 40, a question module via user interface 30 presents prompts and questions and receives responses. Information received via user interface 30 is added to database 20 to develop a basic user profile. User interface 30 may utilize an interactive touch screen computer system in the casino environment, a resident application installed on smart phones and tablet computing devices, or a website accessed online.

At 50, system 10 prompts a user via interface 30 for information regarding preferences. These preferences relate to the type of information that a player wants to use in deciding on their wagers, or bets. One possible category of information is statistics derived from the historical performance of racers. Another possible category of information is background facts relating to a racer which are not statistics related, such as the colors for the racer, birthday of the racer, or other non-statistical characteristics. Additionally, some embodiments of the system may include a preference where the system generates a pick for the player. The responses to preference prompts are also stored in the database and associated with the player.

After system 10 has received and stored a profile of a user and user preferences, it processes the user information and the race information to determine a set of suggested wagers. At 60, system 10 presents race information in graphical formats and the suggested wagers. The race information presented is selected based on the preferences selected by the user or player. For example, if the user has indicated a preference for statistical race data, the graphics will show statistics related to the race.

The player decides on what wagers he desires to place, and at 70 the player inputs his choices into system 10 via user interface 30. Having received the selected wagers, system 10 may produce a printout for the user at 80. The user can then place his wagers through the tote system or place the wager at a teller window.

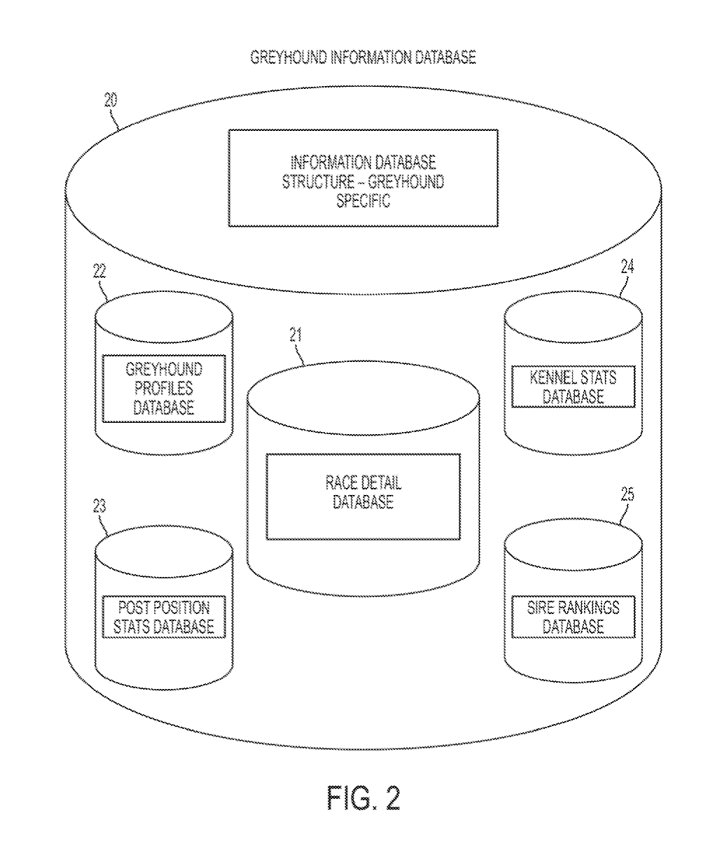

FIG. 2 shows database 20 at the core of system 10 with several sets of tables and data sets within it. In FIG. 2, database 20 is specific to greyhound racing. This is as an example only, and database 20 could have data relating to thoroughbred racing, or other types of contests upon which wagers may be placed. Among the data sets present in the embodiment of database 20 shown in FIG. 2 are race detail data set 21, greyhound profiles data set 22, post position stats data set 23, kennel stats data set 24, and sire rankings data set 25. Each of these data sets contains information that can be used to evaluate the entries in the race and the race overall and this demonstrates the large amount of information confronting a novice player.

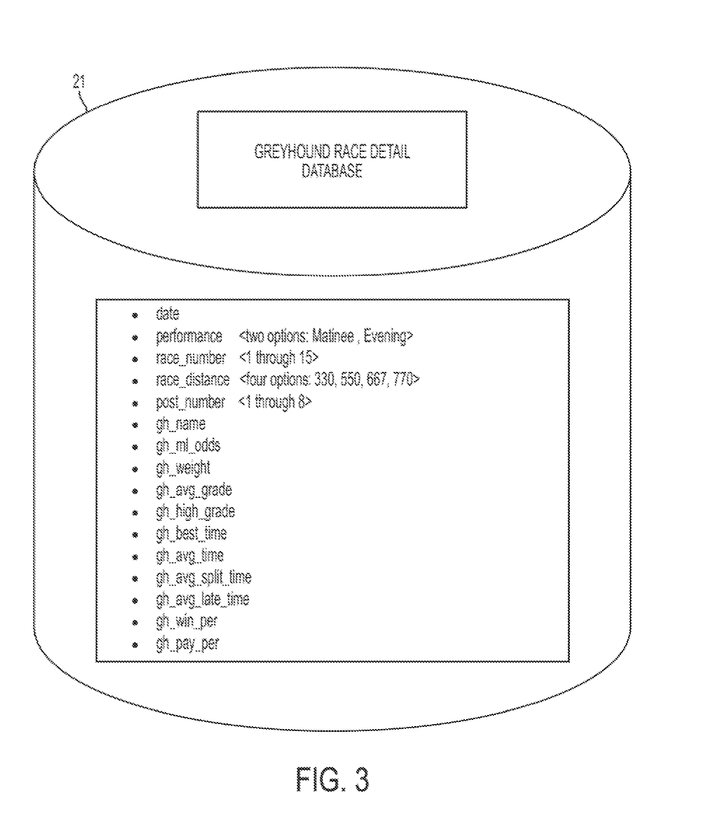

FIG. 3 shows an embodiment of a data set pertaining to race details. Race detail data set 21 contains information about the race and the racers entered in the race. Information fields pertaining to the race more generally may comprise the date of a race, the time of day of a race, the place order of a race, the race distance, and the number of entries in the race. Race data set 21 may also have information about the individual entries. Information about individual entries may include: greyhound name; greyhound weight; the best time of a greyhound within the race; the average time of greyhounds in the race; similar information about split times; and information about the average grade of greyhound in the race and the high grade in the race, where grade refers to a system of rating used within the greyhound racing industry. Other information relating to the race may be present in race detail data set 21.

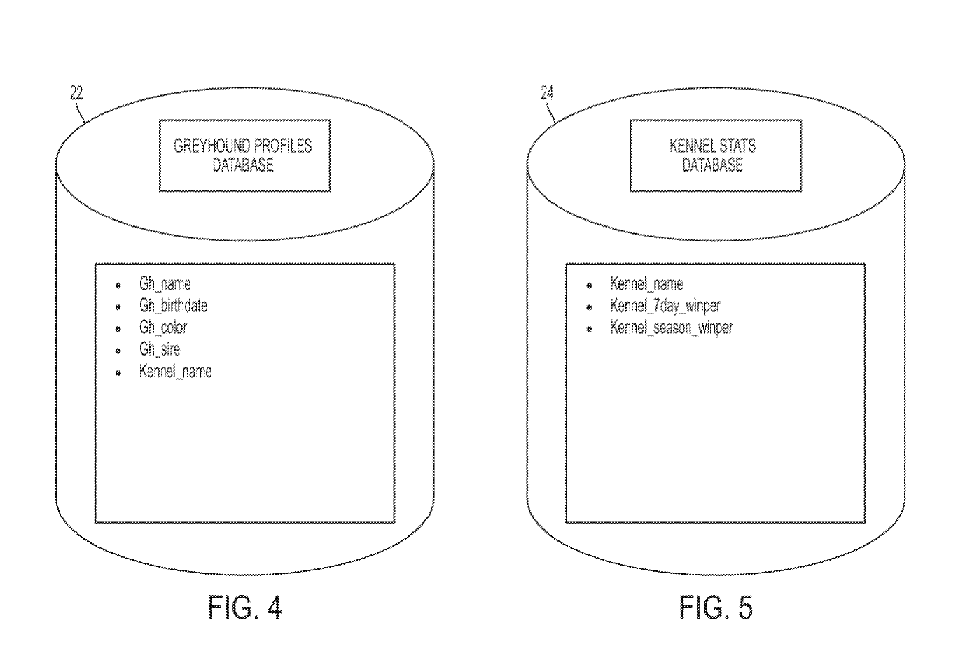

FIG. 4 shows an embodiment of a data set pertaining to greyhound profiles. Greyhound profiles data set 22 may contain such background information about a particular entry as greyhound name, greyhound birthdate, color worn by the greyhound, the greyhound sire, and the kennel from which the greyhound derives. Several of these pieces of background information, such as name, birth date, and color may be perceived as lucky factors. The kennel identifier for a greyhound may provide useful information if a greyhound derives from a successful kennel.

FIG. 5 shows an embodiment of a data set pertaining to kennels supplying greyhounds for races. Kennel stats data set 24 can contain the following information fields: kennel name; the kennel's winning percentage over a recent time interval such as the last week; and the kennel's winning percentage over the season. Information about the kennels can be useful for a player wanting to know if a kennel is generally successful or perhaps is on a successful streak which might reflect on a greyhound from that kennel.

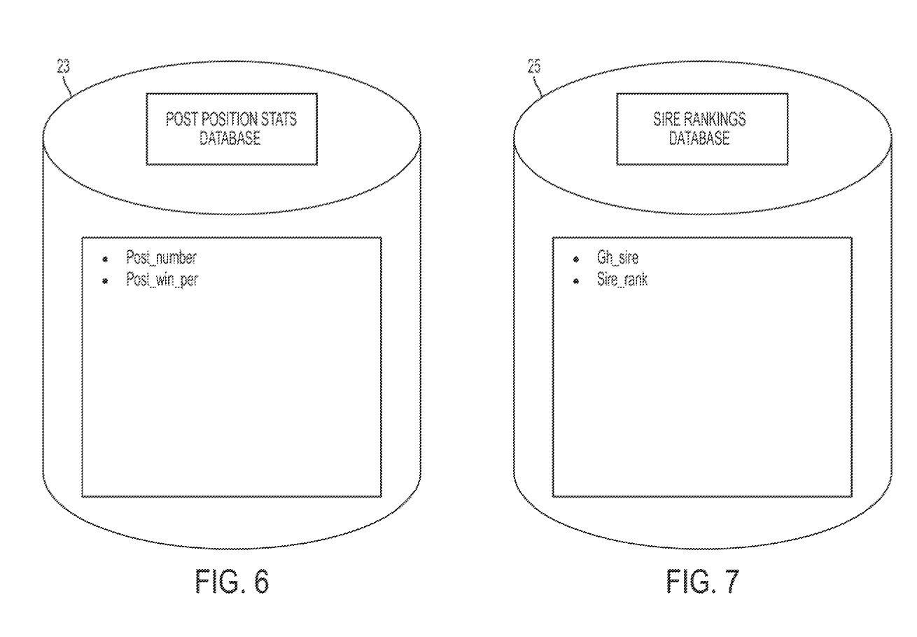

FIG. 6 shows an embodiment of a data set pertaining to post positions. Post position stats data set 23 contains data about the winning percentages of post start positions based on the winning percentages of racers at each post start position. This information allows a player to balance other strengths and weaknesses of racers with their post start position.

FIG. 7 shows an embodiment of a data set pertaining to sires of greyhounds entered in a race. Sire rankings data set 25 contains information about the sires of the greyhounds. This information can include the sire of a greyhound and the rank of the sire and can inform a player about the blood lines of entries in a race. Also, information about the sire of a greyhound may also have some lucky factor implications for some players.

While the data sets within database 20 of FIGS. 4-7 are oriented toward greyhounds, many of the individual data fields could apply to other types of racers such as thoroughbreds and trotters. For example, the name of a racer and the color worn by the racer would also be viewed as lucky factors in other forms of racing. Parentage, stable (instead of kennel), post position, and other information would be useful in handicapping thoroughbreds and trotters as well as greyhounds

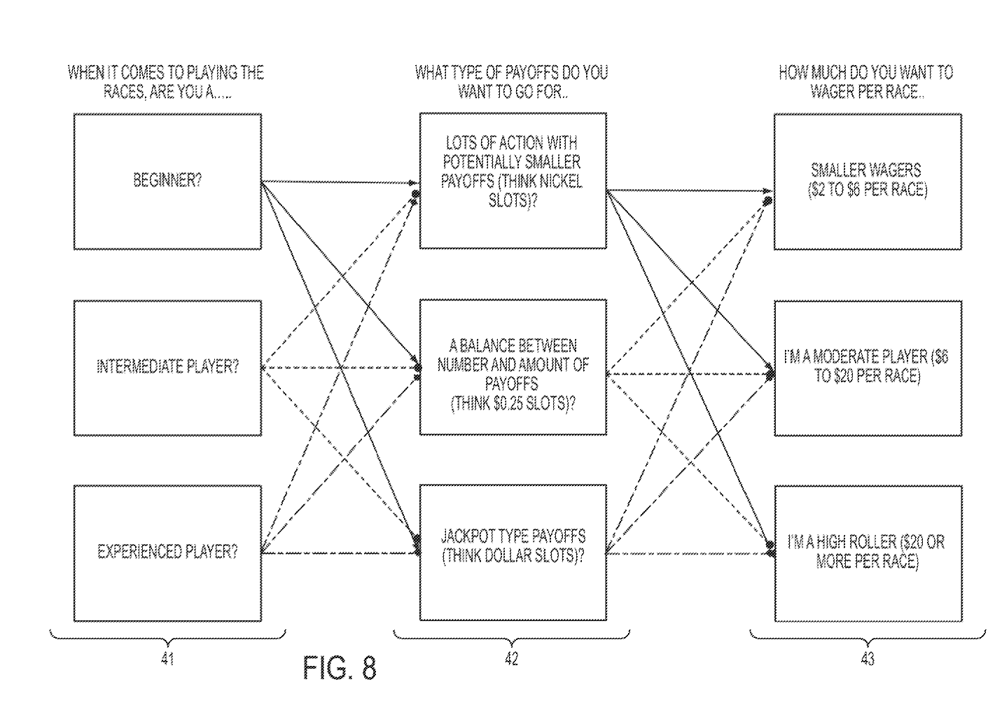

FIG. 8 illustrates the steps and questions used to establish an initial player profile in one embodiment of system 10. The steps and questions are displayed on user interface at 40 in FIG. 1. Initially, a user indicates his experience level in playing the races at 41. Then the player indicates at 42 his betting style preference. He can indicate a preference for simpler, but more frequent wagers, or a preference for more complex wagers with larger payoffs. Finally, at 43, a player can assign a dollar range he is willing to risk at each bet. While this embodiment of system 10 employs the prompts and subject matter just discussed, other embodiments may employ additional, or fewer, questions and prompts addressing player profiles.

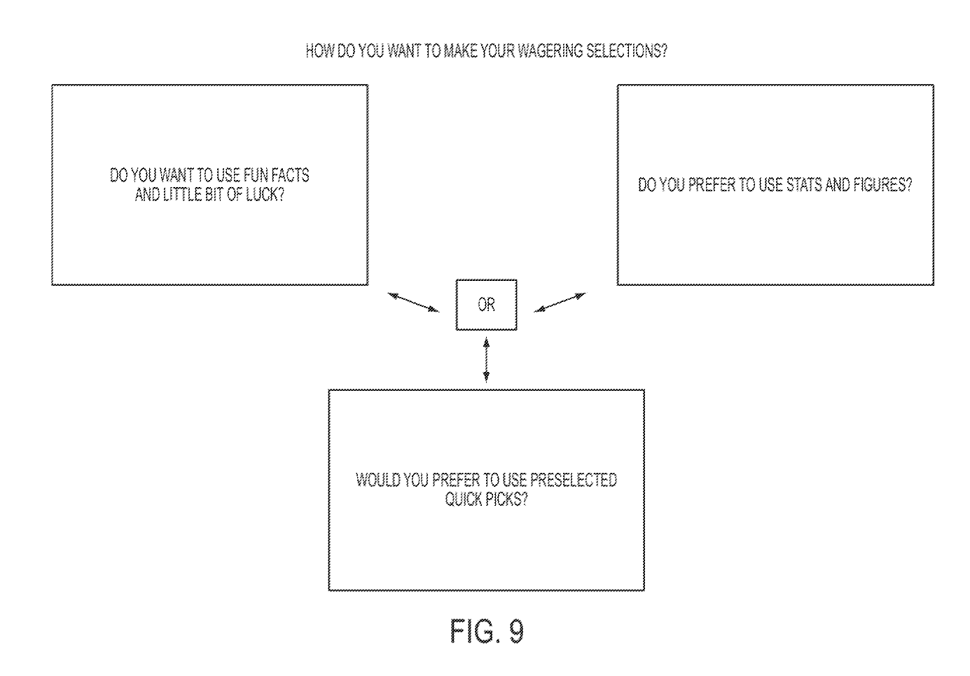

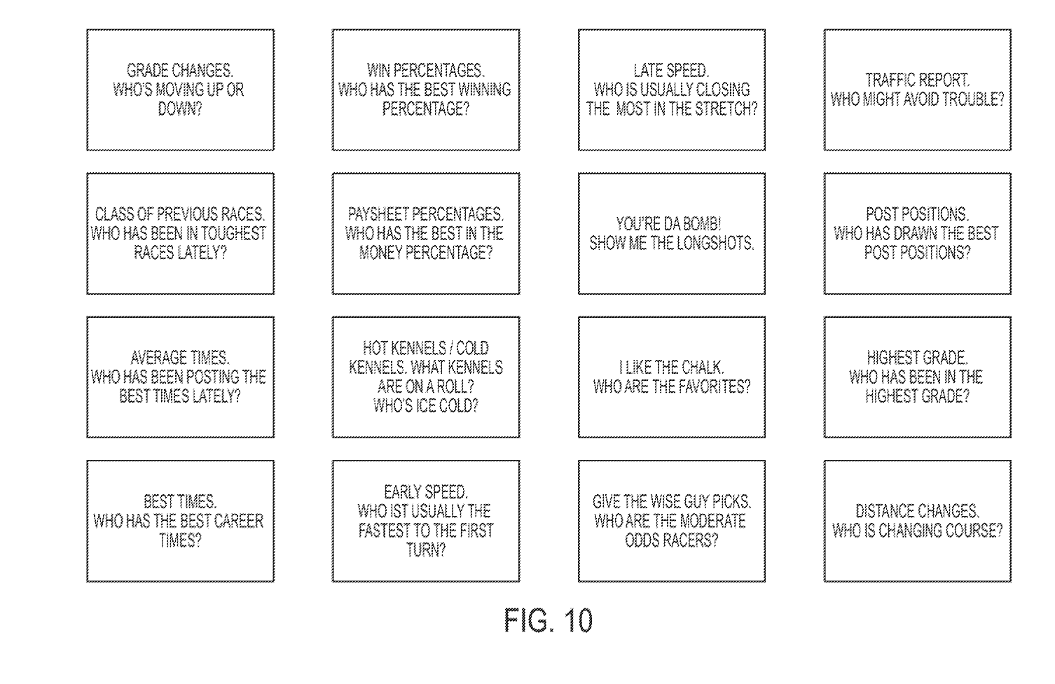

FIG. 9 illustrates another input a player can make to system 10 via user interface 30 at 50 in FIG. 1. A player can select what type of information he would like to be presented when making his wager choices. In the embodiment partially shown in FIG. 9, a user can register a preference for statistics and figures, a preference for fun facts and luck factors, or a user can request automated quick picks from the system.

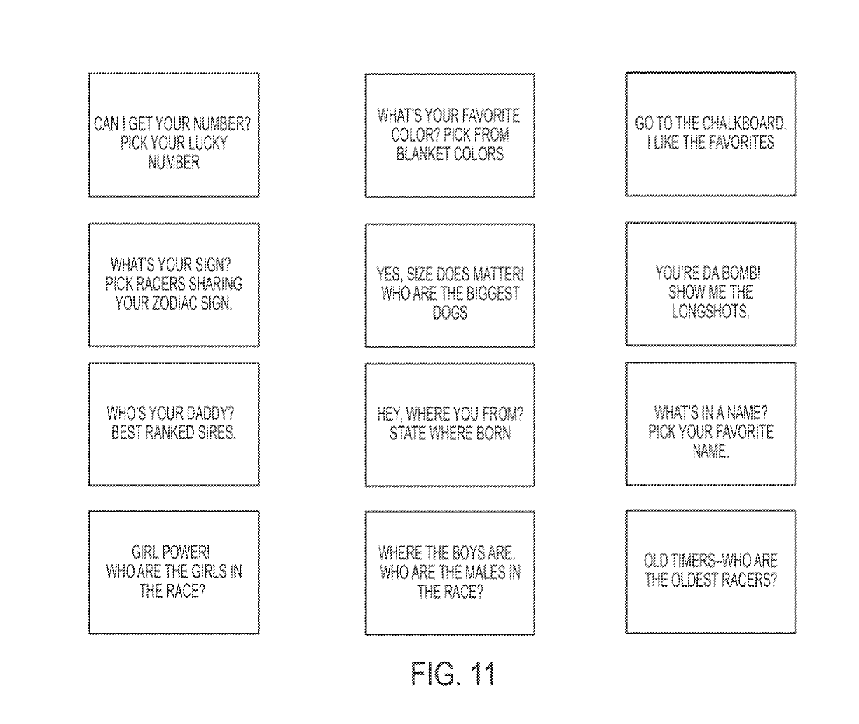

Once a player has selected a broader category of information as a preference for selecting wagers at 50 in system 10 in FIG. 1, additional selection prompts are presented to the player. FIGS. 10 and 11 show possible selection prompts presented based on the previous selection. FIG. 10 illustrates additional selections a player can make regarding the type of statistical information a player prefers to use to make his wagers. FIG. 11 illustrates additional selections a player can make regarding the type of fun fact information a player prefers to use to make his wagers.

As may be seen in FIG. 10, there are a substantial number of statistical categories available to a player. In at least one embodiment of system 10, a player selects four of these categories to use for the basis of making a wager. System 10 takes the statistics from these selected categories and gives a point score to each of the racers in a particular race for that statistical category. System 10 then develops an overall point score for the racers in the particular race. The racers having the highest overall score are then presented as part of the suggested wager to the depth required for a wager, i.e. if three racers need to be chosen then system 10 goes three deep in the overall score, if four racers need to be chosen then system 10 goes four deep in the overall score, etc.

In one embodiment of system 10, to score the racers in a race by a particular statistical category, the racers are ordered by best statistical score to worst statistical score and then awarded points in inverse proportion to their order. For example, if a race has eight racers and the selected statistical category is “Average Finish Times”, the racers can be ordered from fastest to slowest times. Then the fastest racer is given a score of 8 while the second fastest is given a score of 7, etc. The overall score is obtained by adding the scores for each category with the highest sum being the best overall score.

As may be seen in FIG. 11, there are also a substantial number of fun facts categories available to a player. In at least one embodiment of system 10, a player selects four of these categories to use for the basis of making a wager. The player makes their own selection in several of these categories. For example, a player can pick a racer by the name. When a certain fun facts are used, the racer selected receives all the points from that category and none of the other racers receive any points from that category. System 10 then develops an overall score for the racers in the particular race. In at least one embodiment, the score is found by totaling the scores for racers across the selected categories. The racers with higher totals have better overall scores. The racers having the highest overall score are then presented as part of the suggested wager to the depth required for a wager, i.e. if three racers need to be chosen then system 10 goes three deep in the overall score, if four racers need to be chosen then system 10 goes four deep in the overall score, etc.

With the large number of categories, it is unlikely that there will be a tie in the overall score for any two racers. In the event of a tie, the first chosen categories are given more weight as tie breakers. For example, if two racers tie in their overall score, the racer having the best score in the first selected category will win the tie breaker. In some embodiments, a player may use a combination of statistical categories and luck categories. In those embodiments, the scores are awarded to racers the same as they are in all statistical picks or all luck factor picks for the respective categories and the overall scores determined from the sum of the category scores. When the luck category points are awarded on an all-or-nothing basis, there will be some bias toward the luck factors. As with the selection process using statistical categories, system 10 steps through an appropriate decision tree to determine how many racers are needed to complete a wager and selects racers to that depth in the overall ranking for the suggested wager.

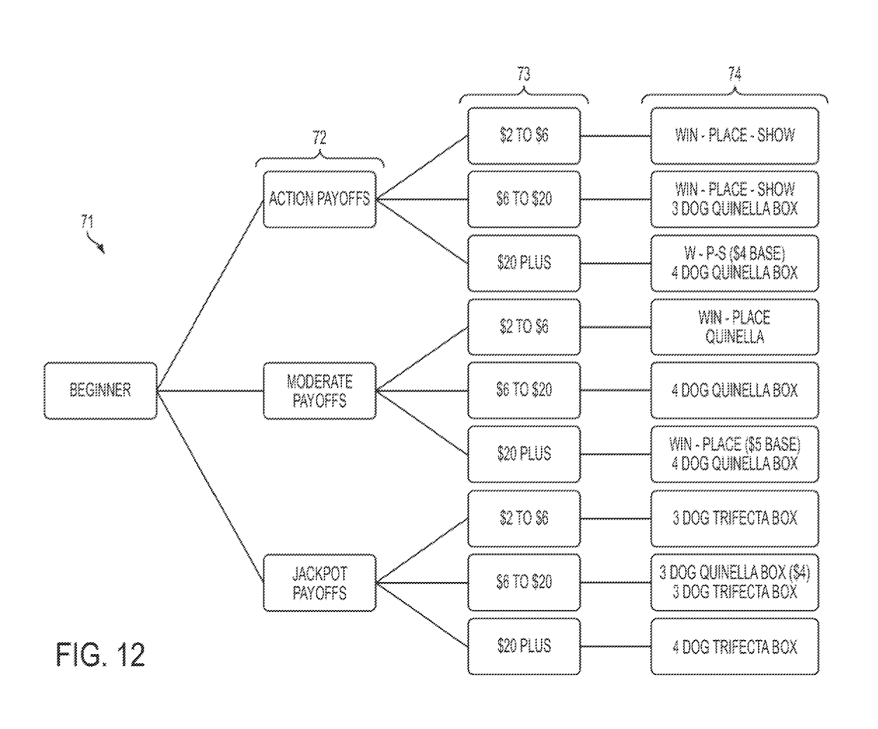

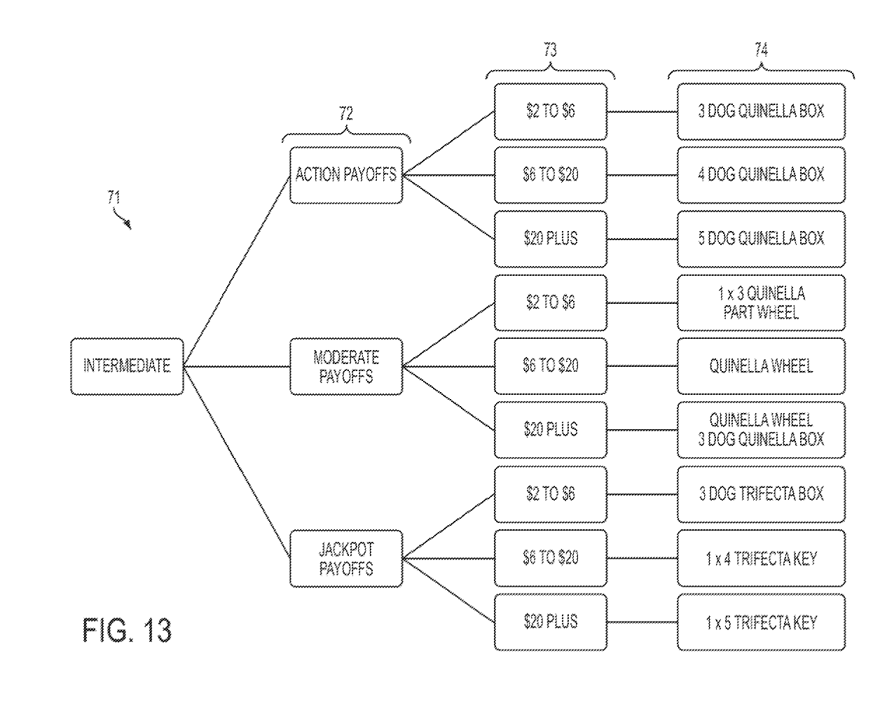

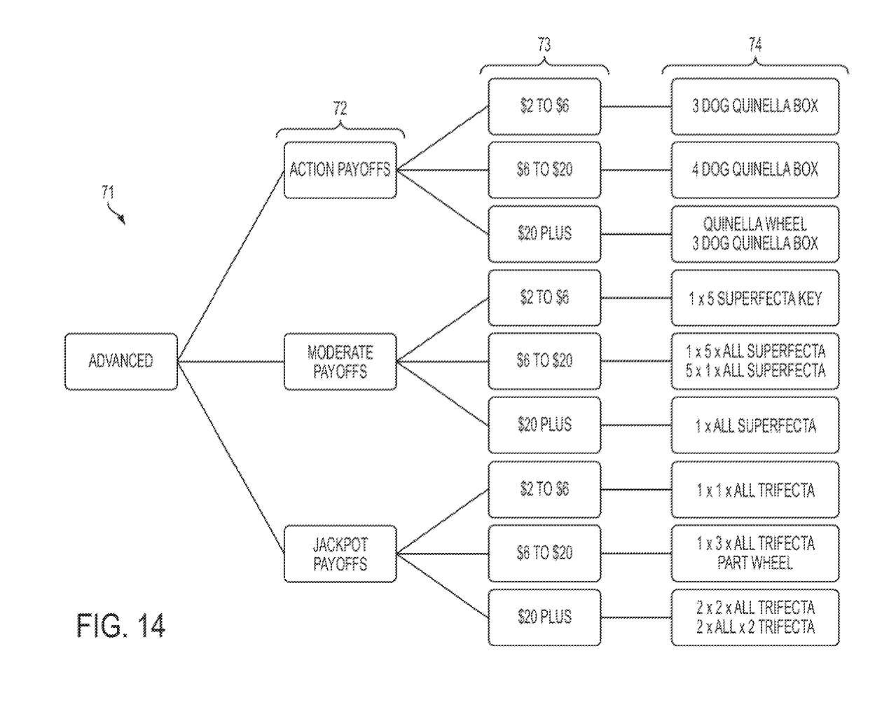

Once the overall scores for the racers are determined, system 10 can formulate suggested wagers for a player. The overall scores for the racers establish a preference order for the racers, and based on previous selections made by a player, system 10 steps through a decision tree 71 to develop a set of suggested wagers for a player. FIG. 12 illustrates a decision tree used to develop wagers for a beginner player based on selections made. FIG. 13 illustrates a decision tree used to develop wagers for an intermediate player based on selections made. FIG. 14 illustrates a decision tree used to develop wagers for an advanced player based on selections made. As an initial step 72 in the decision tree, the type of payoff a player has selected narrows the types of wagers. At the next step 73 in the decision tree, the monetary range that was selected by a player narrows the types of wagers further. These two selections lead to a result at 74 of suggested wagers and the type of suggested wager determines how many racers need to be selected to place the wager. This determines how far down into the overall score ranking system 10 will go to select racers for the suggested wager.

At 60 in system 10, the player is presented with graphs and graphical representation of the selected categories of information and the resulting suggested wagers. These graphical representations of the selected information condense the information and allow a player to visually interpret a large quantity of information to select his wagers. In addition to the graphical representations and suggested wagers, system 10 can present text for suggestions and instructions.

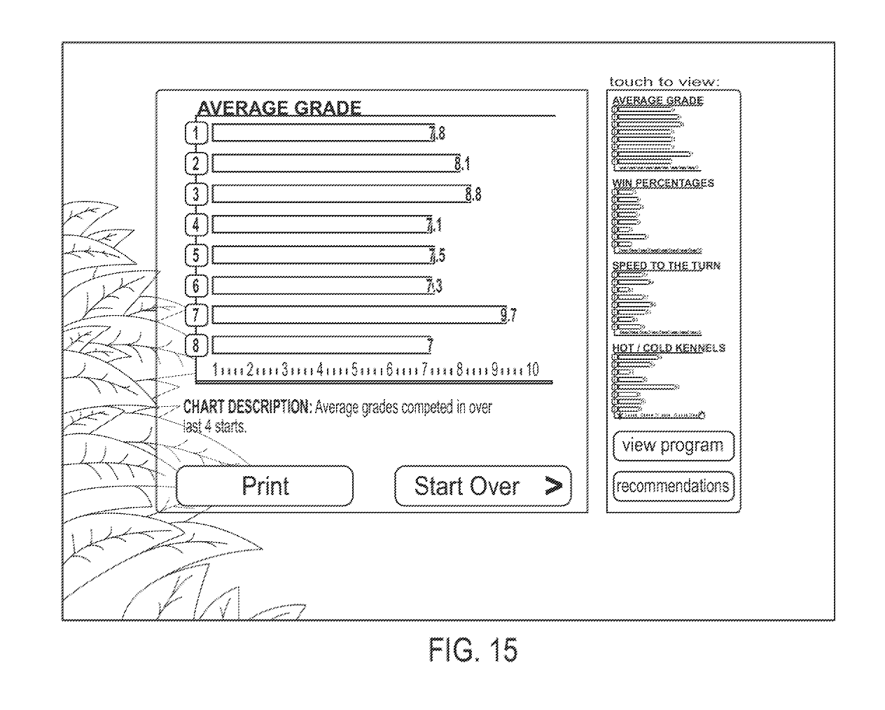

FIG. 15 shows a screen capture from a user interface with a sample graphic for presenting statistical information to a player. In this particular case the graphic employs a bar graph to provide a visual comparison for the average grades in the last four races a greyhound has competed in. This provides a measure of the quality of competition a particular greyhound has faced in recent competitions. Also visible in the screen capture are smaller views of other bar graphs presenting other information. A player can select a full display of one of these graphs by touching it. In the embodiment shown in FIG. 15, a button is provided among the graphics to select to display the wagers suggested by system 10. Once a player has selected the preferred categories of information and reviewed the graphs and graphics generated by the system based on the selected categories of information and the resulting suggested wagers, a player can choose to reverse through the screens to make other selections or proceed to decide about wagers at 70 in system 10.

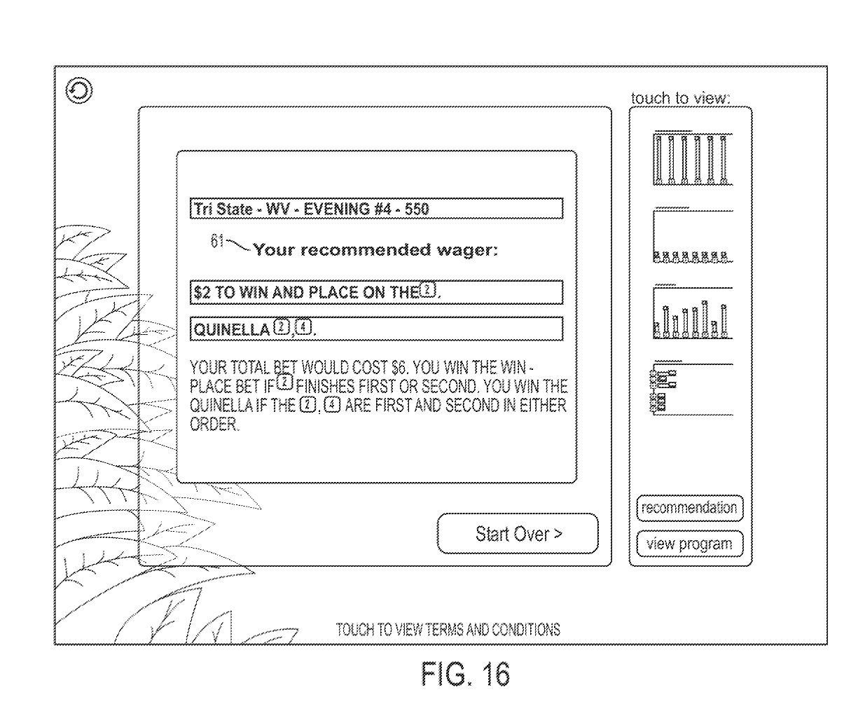

FIG. 16 is a screen capture from a user interface showing a recommended wager 61. The recommendation includes the wager, the cost of the wager, and the possible ways in which the wager wins. The recommendation is derived from both the profile of the user entered by the user as well as the preferences the user enters for the basis of wagers.

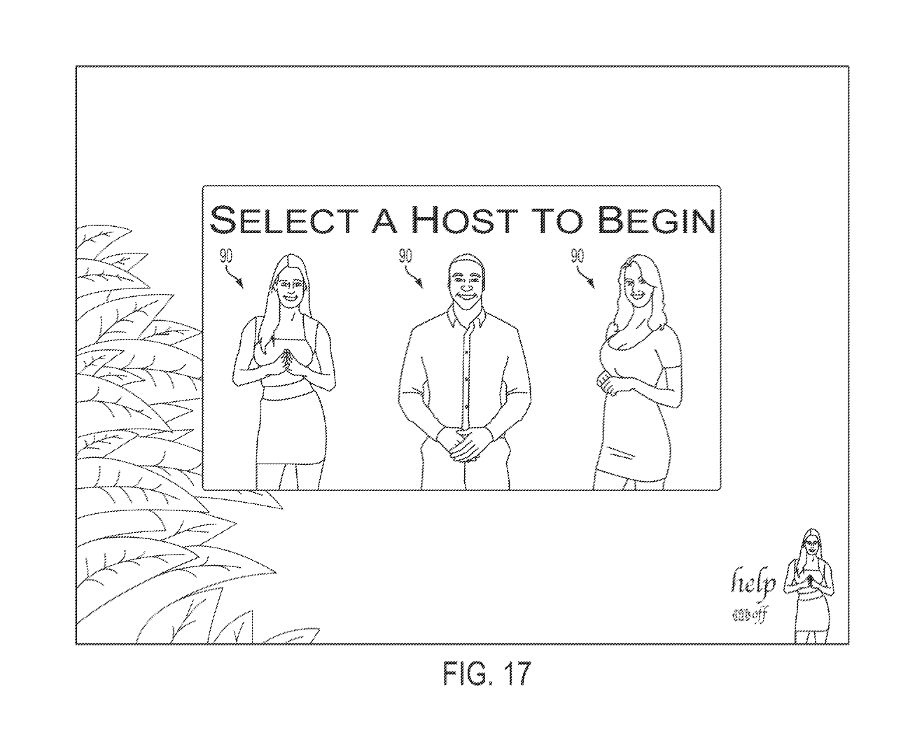

FIG. 17 is a screen capture from a user interface showing possible video hosts 90. In some embodiments of system 10, users may choose to have a video host guide them through the system. The video host audibly describes the process and choices and the system then presents prompts for the various choices. In the embodiment shown in FIG. 17, system 10 allows a user to select from among a set of video hosts 90. In some embodiments of system 10, video hosts 90 may also have characteristics imputed to them in order to illustrate wagering styles or as a basis for recommending a wager. For example, one host may be described as an intermediate player that likes big payoffs and relies upon a certain set of statistics to form wagers. The resulting wagers could be explained to a player as a tool for teaching, or the player could have the option of actually placing the wager resulting from the host profile.

In addition to presenting the suggested wagers to a player electronically at user interface 30, some embodiments of system 10 will have an associated printer and produce a printout of a player's suggested wagers at 80. In addition to printing the suggested wagers of a player, system 10 may print instructions and other information at 80 in system 10. For example, beginners may be given explicit instructions on how to place their wagers. Having made their wager selections at 70, players can place their wagers through a link to the tote system or at a teller window.

Table 1 below provides a list of what types of graphs may be used by system 10 to present a particular statistic.

TABLE 1

| Statistic | Graph Type | Baseline/Top | Increments | Sort By | Graph Title | X Axis Title | Y Axis Title |
|---|---|---|---|---|---|---|---|
| Recent | VERTICAL | 0 (M) to 6 | Each full | X axis | Recent | Box | Average |
| Avg. | BAR | (AA) | number/ | sorted by | Grade | Number | Grade |
| Grade | | | letter | box number | Races | | |
| Recent | LIST | N/A | Digital | Y axis | They're | N/A | Miles Per |
| Avg. | | | speedometer | sorted by | going | | Hour |
| Times | | | | box number | how fast?! | | |
| Best Time | LIST | N/A | Digital | Y axis | They were | N/A | Miles Per |
| | | | speedometer | sorted by | going how | | Hour |
| | | | | box number | fast?! | | |
| Win % | VERTICAL | Scale to fit | 5 percent | X axis | Win | Box | Percent |
| | BAR | the | | sorted by | Percentage | number | |
| | | data range | | box number | | | |
| Hot | Scatter Plot | 0 to 30 | 2 percent | X axis | Hot Kennels | Box | Kennel Win |
| Trainers | | Percent | | sorted by | in | Number | Percentage |
| | | | | box number | Last 7 Days | | |
| Best Early | HORIZONTAL | 32 to 36 | 0.5 MPH | Y axis | Best Early | Miles Per | Box Number |
| Speed | BAR | Miles | | sorted by | Speed | Hour | |
| | | per hour | | box number | | | |
| Best Late | HORIZONTAL | 34 to 38 | 0.5 MPH | Y axis | Best Late | Miles Per | Box Number |
| Speed | BAR | Miles | | sorted by | Speed | Hour | |
| | | per hour | | box number | | | |
| % in Money | VERTICAL | Scale to fit | 5 percent | X axis | Percent in | Box | Percent |
| | BAR | the | | sorted by | Top | number | |
| | | data raange | | box number | Four | | |
| | | | | | Finishers | | |
| Highest | VERTICAL | 0 (M) to 6 | Each full | X axis | Highest | Box | Average |
| Grade | BAR | (AA) | number/letter | sorted by | Grade | Number | Grade |
| | | | | box number | Competed In | | |

Table 2 below lists the types of responses system 10 will generate when a particular lucky factor, or background fact, is chosen.

TABLE 2

| Statistic | Graph Type | Baseline/Top | Increments | Sort By | Graph Title | X Axis Title | Y Axis Title |
|---|---|---|---|---|---|---|---|
| Lucky | Return the | N/A | N/A | N/A | Your lucky | N/A | N/A |
| Number | player's | | | | number is . . . | | |
| | selected # | | | | | | |
| What's Your | Listing - | N/A | N/A | Y axis | Greyhound's | N/A | N/A |
| Sign? | Highlight or | | | sorted by | Astrological | | |
| | check | | | box number | sign is . . . | | |
| Who's Your | Listing | N/A | N/A | Yaxis | Greyhound's | N/A | N/A |
| Daddy? | | | | sorted by | Sire is | | |
| | | | | box number | ranked . . . | | |
| Favorite | Return the | N/A | N/A | N/A | Your favorite | N/A | N/A |
| Color | player's color | | | | color is . . . | | |
| Size | VERTICAL BAR | 50 to 85 | 5 pounds | X axis | Greyhound | Box | Set weight |
| Matters! | | | | sorted by | set | number | |
| | | | | box number | weight | | |
| Betting | Listing - | N/A | N/A | N/A | Favorites - | N/A | Win odds |
| Favorites | highlight or | | | | Morning line | | to $1 |
| | check | | | | betting odds | | |
| Longshots | VERTICAL BAR | $0 to $25 | 2 dollars | Xaxis | Longshots - | Box | Win odds |
| | | | | sorted by | Morning line | Number | to $1 |
| | | | | box number | betting odds | | |
| Old Timers | HORIZONTAL | 15 to 60 | 6 months | Y axis | Old Timers - | Months | Box |
| | BAR | months | | sorted by | Age in months | | number |
| | | | | box number | | | |
| Young Pups | Listing - | N/A | N/A | Y axis | Young Pups - | N/A | N/A |
| | Highlight or | | | sorted by | Age in months | | |
| | check | | | box number | | | |
| | selection | | | | | | |

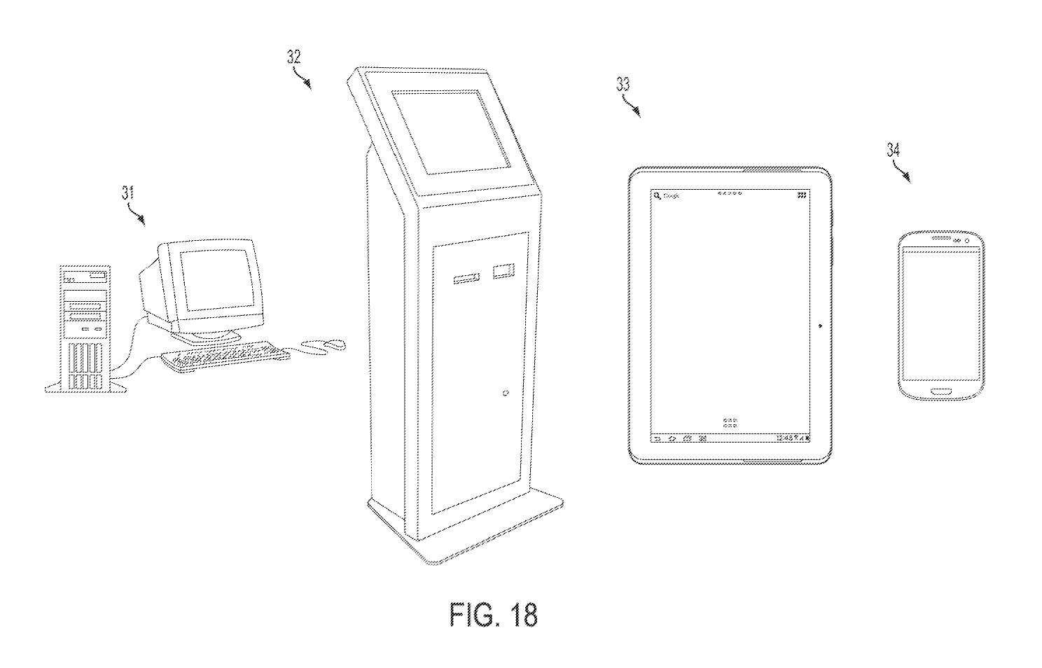

The interactive program system 10 can be resident on and operate through various hardware elements. FIG. 18 shows several possible user interfaces. A desktop PC 31 may be used as a user interface 30 or can operate as the site of database 20. Various other devices may operate as user interface 30 as well, such as a touch screen monitor or kiosk 32, computer tablets 33, or smart phones 34, etc. Additionally, laptop personal computers can be used like desktop personal computer 31, computer tablets 33, or smart phone 34. Database 20 may be located on a remote server and connect to other elements of system 10 via a hard line or via wireless networking. When computer tablet 33 or smart phone 34 are used as user interfaces, computer tablet 33 or smart phone 34 can download just enough of the application to interface with the broader system. Computer tablet 33 or smart phone 34 can interact with the broader system via a general Internet wireless connection or via a propriety wireless connection within a gaming facility. Various peripherals may be incorporated by system 10 such as a smart card reader, bill acceptor, a thermal printer, or a color printer, along with other possible peripherals. In some applications of system 10, a network connection may be employed between system 10 and the totalizer system in place at the race track for placing wagers directly into the wagering pools.

The embodiments discussed herein are not intended to be an exhaustive listing of the possible embodiments of the present invention. They are intended to be illustrative of the present invention and several of the possible embodiments of the invention. The embodiments discussed should therefore not be regarded as limiting the scope of the invention.

Also, when the computer-executable instructions of the interactive program system 10 are stored, the invention is not limited to storage on a particular type of medium. It may be stored on virtually any kind of computer memory. Such computer memory may include floppy disks, conventional hard disks, CD-ROM, Flash ROMS, non-volatile ROM, RAM, and CD-RW.

I claim:

1. A wagering instruction system comprising:
a user interface;
a database, said database storing information about participants in races, and information about system users;
a question module, said question module presenting questions to a user to develop a user profile; and,
a wager generator, said wager generator generating and presenting suggested wagers based upon the developed user profile and stored information about participants in a given race.

2. The wagering instruction system of claim 1, wherein:
said race participants are of one of the following groups;
thoroughbreds,
trotters, and
racing hounds.

3. The wager instruction system of claim 1, wherein:
said user profiles include user experience level, user payout preferences, user monetary range, and user preferred selection information.

4. The wager instruction system of claim 3, wherein:
said user preferred selection information of one of the following groups;
statistical information, and
background information.

5. The wager instruction system of claim 1, wherein:
said user interface is one of the following group:
personal computer;
computer terminal;
tablet computer; and,
smart phone.

6. The wager instruction system of claim 1, wherein:
said question module comprises a video host, said video host guiding a user through the question process.

7. The wager instruction system of claim 1, wherein:
information about said race participants is presented to a user with graphs.

8. The wager instruction system of claim 1, wherein:
said wager generator generates a suggested wager for a user without receiving preferences from the user.

9. The wager instruction system of claim 1, wherein:
the user may confirm and place the wager through the user interface.

10. A method of generating suggested parimutuel wagers comprising:
storing information about a given race and its participants in a database, said information including multiple statistical and background categories about said participants;
submitting profile questions to a potential wagerer via a user interface;
developing a profile of said wagerer based upon the answers to said profile questions;
eliciting from said wagerer via said user interface preferred information categories for evaluating participants;
evaluating the participants in a given race according to said preferred information categories; and,
suggesting a wager to said wagerer based upon said evaluation of said participants and said profile of said wagerer.

11. A computer program for providing information to a user, said computer program comprising;
a database of statistical information categories and background information categories about participants in a race;
a question module for asking questions of a user to develop a user profile and for asking said user for user preferred information categories for evaluating said participants;
a graphical user interface to present said questions and information categories to said user; and,
a scoring module, said scoring module scoring said participants based on said user preferred information categories, and determining higher scoring participants in said race;
said graphical user interface presenting said higher scoring participants to said user.
